(19) United States
(12) Patent Application Publication
(10) Pub. No.: US 2002/0015008 A1
(43) Pub. Date: Feb. 7, 2002

(54) Computer system and headset-mounted display device

(76) Inventors: Ken Kishida, Ome-shi (JP); Michiyuki Terasawa, Iruma-shi (JP); Nobutaka Nakamura, Hidaka-shi (JP); Shinichi Furuta, Akishima-shi (JP); Hiroshi Nishibayashi, Ome-shi (JP); Tadayuki Matsubara, Tokyo (JP)

Correspondence Address: Finnegan, Henderson, Farabow,, Garrett & Dunner, L.L.P., 1300 I Street, N.W., Washington, DC, 20005-3315, US

(21) Appl. No.: 09/903,591

(22) Filed: Jul. 13, 2001

(30) Foreign Application Priority Data
Jul. 14, 2000 (JP) 2000-214514

(51) Int. Cl. G09G 5/00

(52) U.S. Cl. 345/7

(57) ABSTRACT

A computer can be provided with small-sized, light-weight, and furthermore cableless features by efficiently positioning the components of the computer and display device. The computer system includes a wearable computer and a wearable display device provided independently of this computer. A display controller is installed in the display device, not in the computer. The computer controls the display controller by radio or wire.

### CROSS-REFERENCE TO RELATED APPLICATIONS

This application is based upon and claims the benefit of priority from the prior Japanese Patent Application No. 2000-214514, filed Jul. 14, 2000, the entire contents of which are incorporated herein by reference.

### BACKGROUND OF THE INVENTION

1. Field of the Invention

The present invention relates to a computer system and a headset-mounted display device and more particularly to a computer system and a headset-mounted display device which can be worn on the body for works. 2. Description of the Related Art

In recent years, computers have been reduced in size and lighter in weight with the advancement of semiconductor technology, computer technology, and the like. Various mobile computers have been developed, such as the notebook-type and pocket-type products. Most recent developments include computers which can be worn on the body.

A wearable computer has, say, a computer body which can be worn around the waist, and a headset-mounted display device. A cable is used for connection between the computer and the display device. Such a wearable computer enables hands-free work such as repairing high-tech devices by displaying and ensuring design data on the screen.

However, a conventional wearable computer is so configured that almost all computer components except the display monitor are placed in the computer body. This does not take full advantage of a wearable computer with respect to the computer size and weight. Since this configuration generates heat like an ordinary notebook computer, a countermeasure against heat dissipation is a hindrance to a sufficiently small-sized and light-weight design. Further, there may be the case where a connection cable between the computer and the display device obstructs works.

Of computer components, major heat sources are high-speed devices such as processors and display controllers. Since the same computer body contains the processor and the display controller, it is difficult to decrease the body size and the body temperature increases accordingly. Since the cable is used to transmit display data for refreshing the screen to the display device, a large amount of data is always supplied via the cable for refreshing the display screen. It is conceivable to use a radio signal for connection between the computer and the display monitor. However, radio communication places restrictions on data transfer rates. Practically, it is difficult to use a radio signal to transmit display data for refreshing the screen.

### BRIEF SUMMARY OF THE INVENTION

Accordingly, it is an object of the present invention to provide a computer system and a headset-mounted display device capable of being small-sized, light-weight and cableless, and allowing a user wearing the computer and the display device to work efficiently.

According to one aspect of the present invention, there is provided a computer system comprising: a wearable computer; and a wearable display device provided independently of the wearable computer, wherein the wearable display device includes: a display monitor, and a display controller which controls the display monitor and draws in a memory display data to be displayed on the display monitor based on drawing command information from the wearable computer.

According to another aspect of the present invention, there is provided a computer system comprising: a wearable computer; and a wearable display device provided independently of the wearable computer and having a wearable headset-mounted casing, wherein the wearable computer and the wearable display device each include a communication interface for radio communication with each other, and the wearable display device includes: a display monitor, and a display controller which controls the display monitor and draws in a memory display data to be displayed on the display monitor based on drawing command information transmitted from the wearable computer by radio.

According to still another aspect of the present invention, there is provided a headset-mounted display device constituting a computer system together with a computer, the headset-mounted display device comprising: a display monitor; and a display controller which controls the display monitor and draws in a memory display data to be displayed on the display monitor based on drawing command information transmitted from the wearable computer by radio.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently embodiments of the invention, and together with the general description given above and the detailed description of the embodiments given below, serve to explain the principles of the invention.

FIG. 1 is a block diagram showing a configuration of a computer system according to an embodiment of the present invention;

FIGS. 2A and 2B illustrate an external view of a headset-mounted display device used for the computer system according to the embodiment and an example of attachment thereof to a user;

FIG. 3 is a block diagram showing a second configuration example of the embodiment;

FIG. 4 is a block diagram showing a configuration example of a radio communication interface used for the system according to the embodiment;

FIG. 5 is a block diagram showing another configuration example of a radio communication interface used for the system according to the embodiment;

FIG. 6 is a block diagram showing yet another configuration example of a radio communication interface used for the system according to the embodiment;

FIG. 7 is a block diagram exemplifying a concrete configuration of a computer used for the system according to the embodiment;

FIG. 8 is a block diagram showing a configuration example of the computer when the headset contains part of the sound function installed in the computer used for the system according to the embodiment;

FIG. 9 shows a configuration of a headset compliant with the computer in FIG. 8;

FIG. 10 is a block diagram showing a configuration of the sound function used for the system according to the embodiment;

FIG. 11 is a block diagram showing a configuration example of the computer when the headset contains part of the sound function installed in the computer used for the system according to the embodiment;

FIG. 12 shows a modification of the configuration in FIG. 11;

FIG. 13 shows a configuration of a headset compliant with the computer in FIG. 11 or 12;

FIG. 14 shows another example of the headset used for the system according to the embodiment;

FIG. 15 shows yet another example of the headset used for the system according to the embodiment;

FIG. 16 illustrates a headset-mounted display and a visual line recognition camera installed on the headset in FIG. 15;

FIG. 17 illustrates a configuration for controlling image capturing directions of a video camera installed on the headset in FIG. 15; and

FIG. 18 illustrates a system for zoom-controlling the image capturing directions of a video camera installed on the headset in FIG. 15.

### DETAILED DESCRIPTION OF THE INVENTION

Embodiments of the present invention will be described with reference to the accompanying drawings.

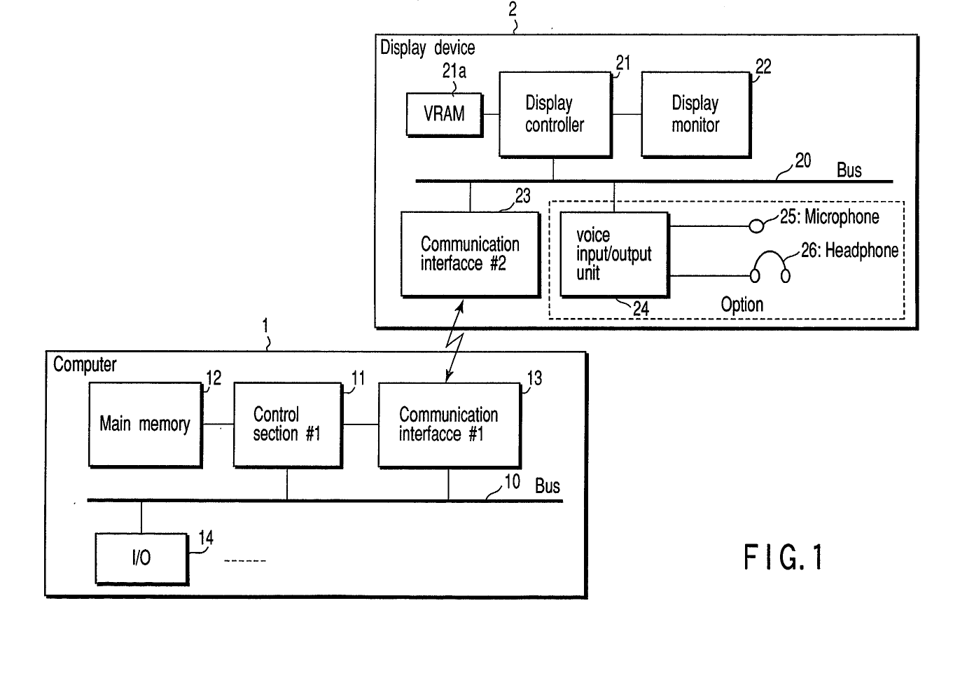

FIG. 1 shows a configuration of a computer system according to an embodiment of the present invention. This computer system provides a wearable computer which, can be worn on the body. The computer system includes a computer 1 and a display device 2 provided independently of the computer 1. Namely, a casing of the computer 1 is separated from a casing of the display device 2. It is possible for the computer to communicate with the display device by radio. Of course, it is possible for the computer to communicate with the display device 2 by wire as needed. In this computer system, the display device 2 is provided with a display controller. No display controller is provided to the computer 1. The computer 1 controls the display controller by radio or wire.

The computer 1 is attached to the user's waist and the like by means of a belt. As shown in the figure, the casing thereof is provided with a bus 10, a control section 11, main memory 12, a communication interface 13, and various I/O devices 14. The control section 11 includes a CPU (or a combination of the CPU and a host bridge) and controls the whole computer system. The main memory 12 is loaded with an operating system and various application programs executed by the control section 11. The communication interface 13 is provided for communication with the display device 2 and is connected to the bus 10. The communication interface 13 is used for transmitting drawing command information and the like to the display controller on the display device 2.

The display device 2 is, say, a head-mounted display (HMD). As shown in the figure, the casing of the display device is provided with a bus 20, a display controller 21, a display monitor 22, and a communication interface 23. As an option, it is possible to provide a voice input/output unit 24 for implementing the sound function. The communication interface 23 is used for communication with the computer 1. In cooperation with the communication interface 13 on the computer 1, the communication interface 23 works as a bus bridge for interconnection between the bus 10 and the bus 20. Namely, this embodiment employs the configuration which separately allocates the bus used for the system to the computer 1 and the display device 2. Accordingly, the control section 11 in the computer 1 handles each device connected to the bus 20 in the display device 2 in the same manner as each device in the computer 1.

The display controller 21 controls the computer system's display monitor 22. The display controller 21 has the 2D or 3D graphics processing function for drawing display data in a video memory (VRAM) 21a based on the drawing command information such as coordinate data, drawing commands, and other data from the control section 11. Namely, the display controller 21 functions as a graphics accelerator. Of course, the control section 11 can directly access the video memory (VRAM) 21a. The display controller 21 repeatedly reads data from the video memory (VRAM) 21a, converts this data to display data such as R, G, B for refreshing, and then supplies the converted data to the display monitor 22. The voice input/output unit 24 inputs and outputs voice using a microphone 25 and a headphone 26 constituting part of the headset and has the sound source function for converting data from the control section 11 to a voice signal.

As mentioned above, FIG. 1 adopts the configuration which separately allocates the bus used for the system to the computer 1 and the display device 2, allowing the display controller 21 to be placed in the display device 2. This configuration provides the following effects.

1) The control section 11 and the display controller 21 are mounted on the computer 1 and the display device 2, respectively. Accordingly, the volume and the weight can be dispersed into the computer 1 and the display device 2.

2) The control section 11 and the display controller 21 generate a lot of heat and are placed in a casing other than the casing for the computer 1, preventing the entire system's temperature from rising remarkably.

3) The amount of data exchanged between the control section 11 and the display controller 21 is much smaller than that between the display controller 21 and the display monitor 22. Accordingly, radio communication is available between the control section 11 and the display controller 21. The use of radio communication can eliminate an inconvenient cable.

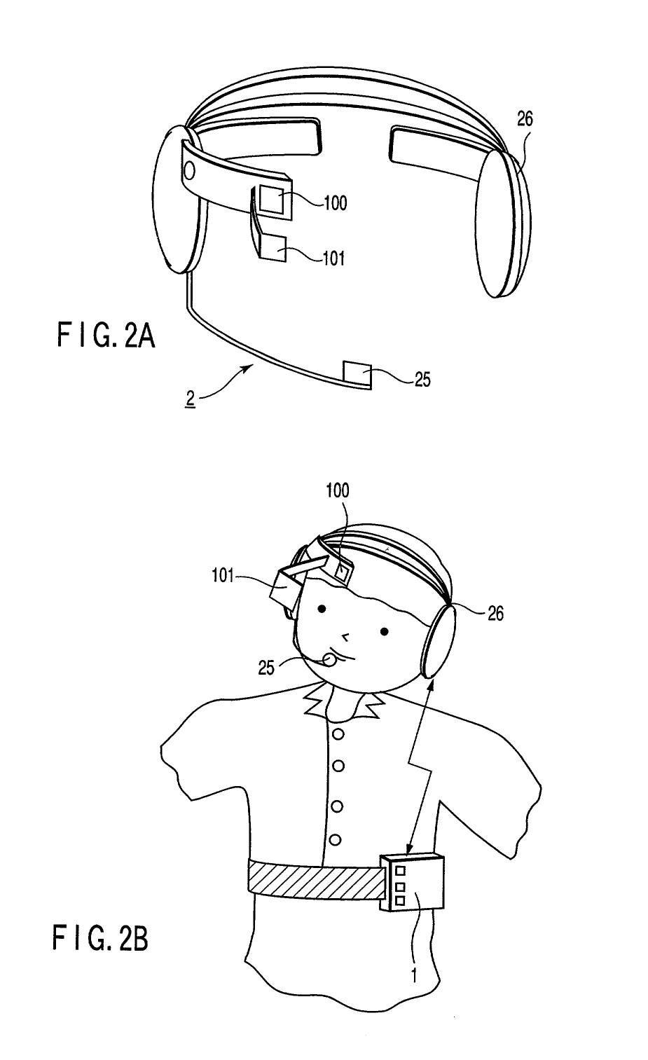

FIGS. 2A and 2B illustrate an external view of the display device 2 and the computer 1 and an example of attachment thereof to a user's body.

As shown in FIG. 2A, the display device 2 has a headset casing integrating the headphone 26 and the microphone 25. The casing is provided with a display 100 and a mirror 101. The display 100 and the mirror 101 provide the above-mentioned display monitor 22. The display 100 projects an image from the display screen onto the mirror 101 which reflects the image. As shown in FIG. 2B, the user can work by viewing the image on the mirror 101 as needed. Of course, it may be preferable to use an ordinary small liquid crystal display for the display 100 so that the display screen faces toward the user.

As shown in FIG. 2B, the computer 1 is attached to the user's waist and the like by means of a-belt. It is possible for the computer to communicate with the headset-mounted display device 2 by radio.

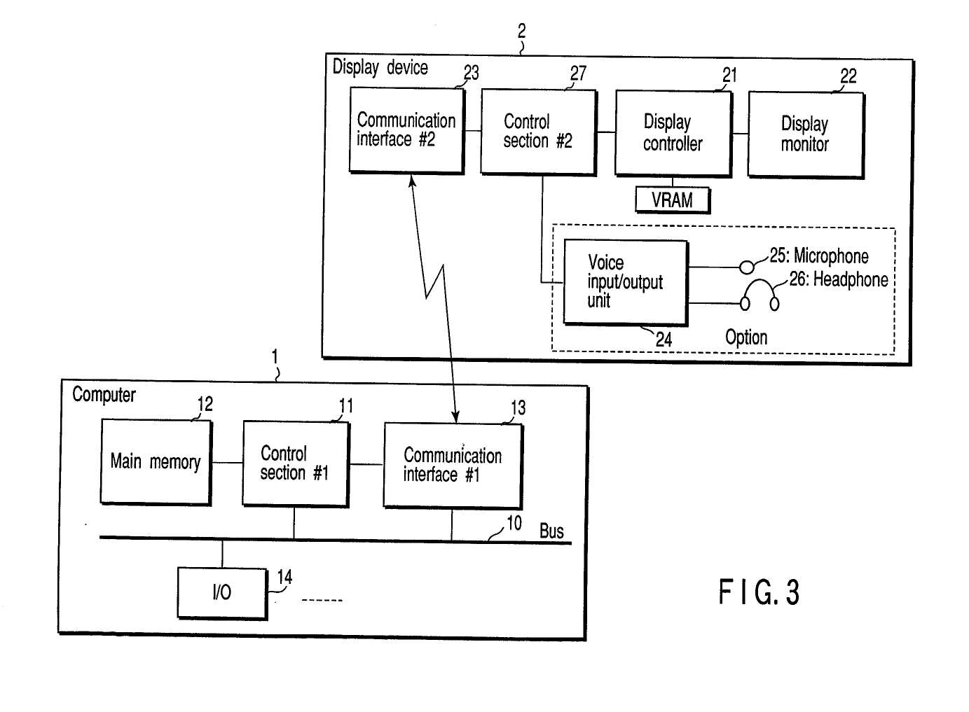

FIG. 3 shows a second configuration example of the display device 2.

To provide the display device 2 with an intelligent function in FIG. 3, the display device 2 further includes a control section 27 having a microcomputer or the like. In this case, the control section 27 controls all devices in the display device 2. Accordingly, the display device 2 functions as one peripheral. This configuration enables voice recognition, voice synthesis, and the like by the display device 2. For example, the control section 27 recognizes a voice signal input from the microphone 25. A recognition result is sent as an operation control command to the computer 1 via the communication interface 23. Thus, voice control obviates the need for keyboard or mouse operations. Voice control is also available in such a configuration that converts a voice signal to a digital signal, sends this signal to the computer 1, and allows the control section 11 to recognize the signal.

As an additional effect, providing the display device 2 with the control section 27 easily provides more advanced communication control such as a retransmission function during communication error occurrence.

Since the control section 27 can be of a smaller scale and less sophisticated than the control section 11, mounting the control section 27 hardly increases the size of the display device 2 or the heat release value.

The following describes the method of radio communication between the computer 1 and the display device 2 implemented by the communication interfaces 13 and 23 in the system of FIG. 1 or 3. It is possible to use radio waves such as Bluetooth, light beams, infrared rays, and ultrasonic waves for radio communication between the computer 1 and the display device 2.

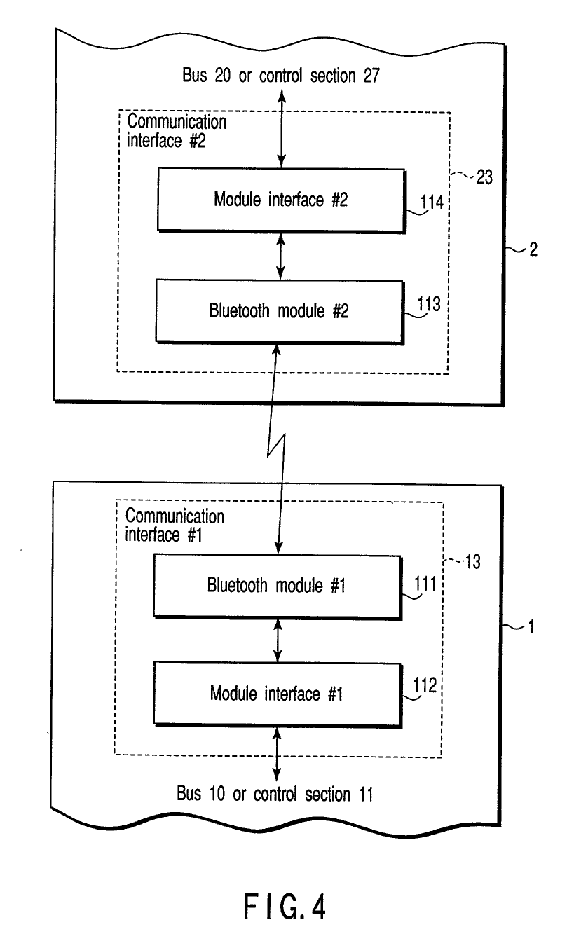

FIG. 4 shows a configuration example of the communication interfaces 13 and 23 using Bluetooth. As shown in the figure, the communication interface 13 for the computer 1 includes a Bluetooth module 111 and a module interface 112. The Bluetooth module 111 provides radio communications according to frequency hopping by using the 2.4 GHz radio band. The module interface 112 provides an interface between the Bluetooth module 111 and the control section 11 or the bus 10. Likewise, the communication interface 23 for the display device 2 includes a Bluetooth module 113 and a module interface 114. The Bluetooth module 113 provides radio communications according to the frequency hopping by using the 2.4 GHz radio band. The module interface 114 provides an interface between the Bluetooth module 113 and the control section 27 or the bus 20. The Bluetooth modules 111 and 113 each include an antenna.

The Bluetooth modules 111 and 113 are predetermined so that they belong to the same radio group (piconet) for bidirectional radio communications according to the Bluetooth standard.

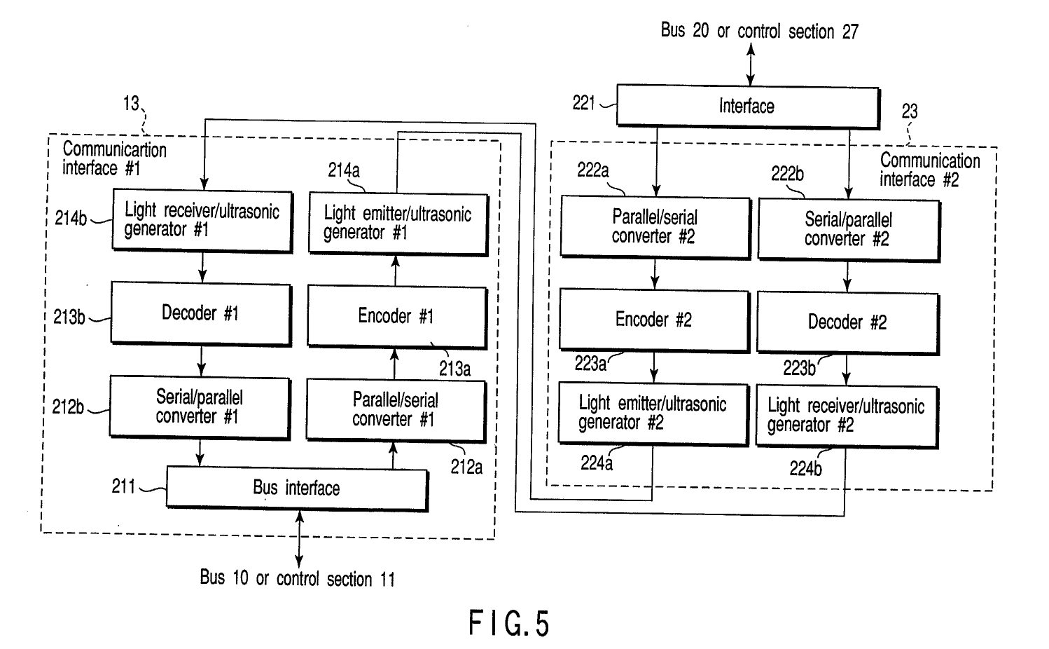

FIG. 5 shows a configuration example using radio signals other than radio waves, namely using light beams, infrared rays, or ultrasonic waves.

Transmission data from the control section 11 in the computer 1 is sent to the bus interface 211 in the communication interface 13 directly or via the bus 10, and then is passed to a parallel/serial converter 212a. The parallel/serial converter 212a performs parallel/serial conversion to convert the transmission data from parallel data to serial data. The serial data is encoded or modulated in an encoder/modulator 213a, and then is transmitted as a light beam or an ultrasonic wave from a light emitter/ultrasonic generator 214a.

In the communication interface 23 for the display device 2, a light receiver/ultrasonic receiver 224b receives a transmission signal from the computer 1 in the form of a light beam or an ultrasonic wave. The received signal is decoded or demodulated in a decoder/demodulator 223b. The decoded or demodulated signal is converted from serial data to parallel data in a serial/parallel converter 222b, and then is sent to the control section 27 or the bus 20 via an interface 221.

The transmission data is passed from the display device 2 to a parallel/serial converter 222a via the interface 221 and then is converted from parallel data to serial data there. The serial data is encoded or modulated in an encoder/modulator 223a and then is transmitted as a light beam or an ultrasonic wave from a light emitter/ultrasonic generator 224a.

In the communication interface 13 for the computer 1, a light receiver/ultrasonic receiver 214b receives a transmission signal from the display device 2 in the form of a light beam or an ultrasonic wave. The received signal is decoded or demodulated in a decoder/demodulator 213b. The decoded or demodulated signal is converted from serial data to parallel data in a serial/parallel converter 212b, and then is sent to the control section 11 via the bus interface 211.

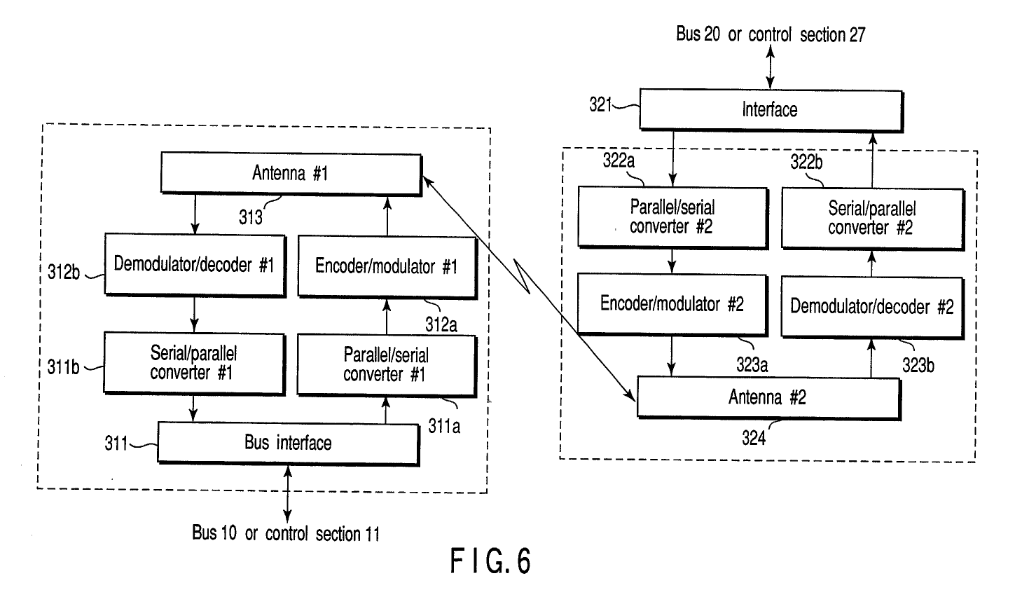

FIG. 6 shows a configuration example using radio waves other than Bluetooth.

Transmission data from the control section 11 in the computer 1 is sent to the bus interface 311 in the communication interface 13 directly or via the bus 10, and then is passed to a parallel/serial converter 311a. The parallel/serial converter 311a performs parallel/serial conversion to convert the transmission data from parallel data to serial data. The serial data is encoded or modulated in an encoder/modulator 312a, and then is transmitted as a radio wave from an antenna 313. This encoding or modulation includes up-conversion and the like needed for RF transmission.

In the communication interface 23 for the display device 2, an antenna 324 receives the radio waves from the computer 1. A demodulator/decoder 323b demodulates or decodes the received signal for the purpose of down-conversion and the like. The processed signal is then transmitted to the control section 27 or the bus 20 via a serial/parallel converter 322b and the interface 321.

Data transmission from the display device 2 to the computer 1 follows the reverse of the above-mentioned sequence. Data passes the interface 321, the parallel/serial converter 322a, the encoder/modulator 323a, the antenna 324, the antenna 313, the demodulator/decoder 312b, the serial/parallel converter 311b, the bus interface 311, and then is transmitted to the control section 11.

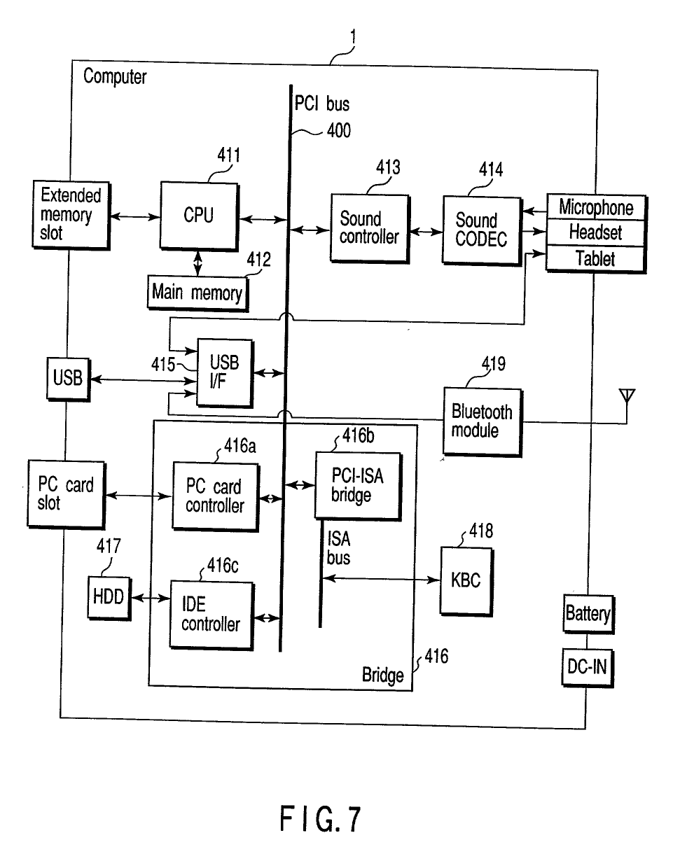

The following describes a concrete configuration of the computer 1 used for the system in FIG. 1 or 3 with reference to FIG. 7.

In FIG. 7, it is assumed that Bluetooth is used for the above-mentioned radio communication interface. As shown in FIG. 7, the computer 1 is provided with a PCI bus 400, a CPU 411, a main memory 412, a sound controller 413, a sound CODEC 414, a USB controller 415, a bridge 416, a HDD 417, a keyboard controller (KBC) 418, and a Bluetooth module 419, and the like. As shown in the figure, the bridge 416 contains a PC card controller 416a, a PCI-ISA bridge 416b, and an IDE controller 416c, and the like.

In FIG. 7, the PCI bus 400 corresponds to the bus 10 for the system in FIG. 3. The CPU 411 corresponds to the control section 11 in FIG. 3. The USB controller 415 and the Bluetooth module 419 correspond to the communication interface 13.

In FIG. 7, the computer 1 is provided with sound circuits such as the sound controller 413 and the sound CODEC 414. In consideration for the use as a wearable computer, it is preferable to provide the display controller with the sound circuits described as option devices in FIG. 1 or 3 like the display controller. This is because it is sufficient to implement the sound function only when the user wears the headset-mounted display device 2. In this case, it is desirable to use a digital communication interface between the computer 1 and the display device 2 with respect to voice signals. The purpose is to improve resistance to external noise. For example, the digital communication interface can be wire (AC97) or radio (Bluetooth).

For efficient use of the digital communication interface, it is important to separate components for processing digital signals into the computer 1 and the display device 2. This also applies to the display control. Accordingly, the system exemplified in FIG. 1 or 3 separates the display controller 21 from the control section 11, and the computer 1 transmits drawing command information in the form of digital data to the display controller in the display device 2.

The following describes the sound function with respect to a concrete configuration of the display device 2.

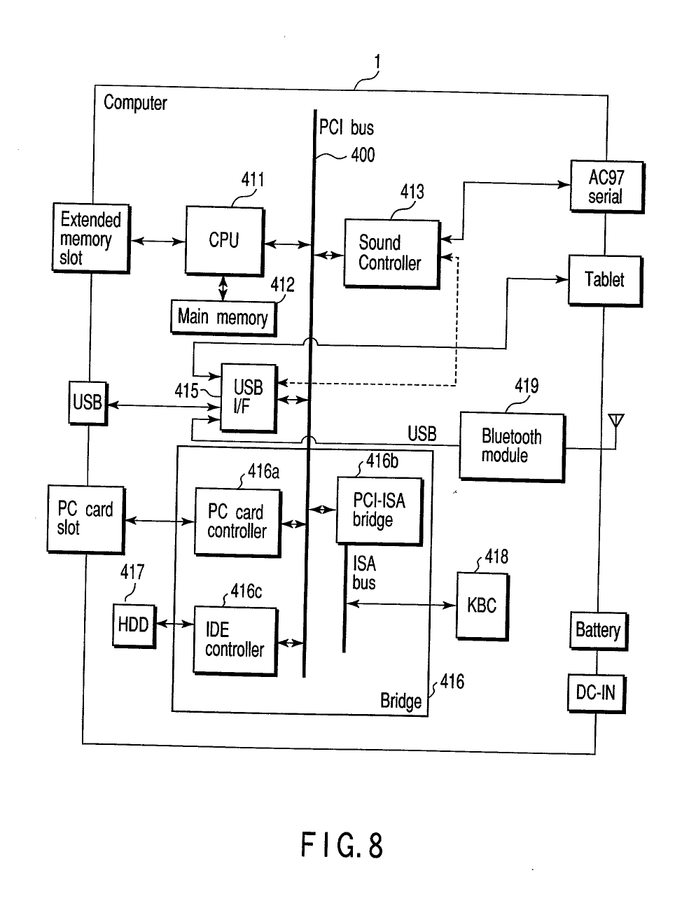

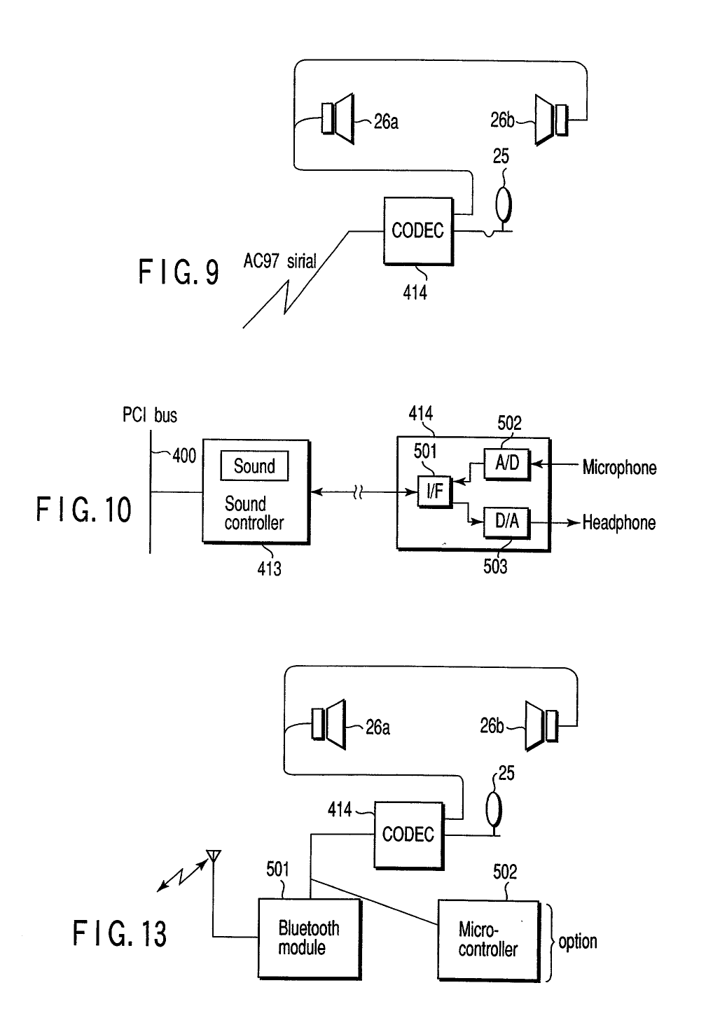

Regarding the sound function according to the configuration example of the computer 1 in FIG. 8, only the sound controller 413 remains in the computer 1 and the sound CODEC 414 is moved to the headset-mounted display device 2. It is possible to use AC97 (serial) or the Bluetooth module 419 common to the interface with the display controller 27 for an interface between the computer 1 and the headset-mounted display device 2's sound CODEC 414. FIG. 9 shows a configuration of the headset using AC97 (serial).

As shown in FIG. 9, the sound CODEC 414 is connected to AC97 (serial) at the headset side and to right and left headphones 26a and 26b and the speaker 25 of the headset 26. As shown in FIG. 10, the sound CODEC 414 includes an interface section 501, an A/D converter 502, and a D/A converter 503. The interface section 501 provides an interface with the sound controller 413 having the sound source function. The A/D converter 502 converts a voice signal from the microphone 25 to a digital signal. The D/A converter 503 converts the digital voice signal generated from the sound controller 413 to an analog signal to be reproduced from the headphone. Originally, a digital interface is used between the sound CODEC 414 and the sound controller 413. Since the headset is separated from the computer 1 at this interface, the digital interface can be used for connection between the computer 1 and the headset.

By using the headset in FIG. 9, it is possible to convert a voice signal from the microphone 25 and transmit this digital signal to the computer 1. It is also possible to convert the digital voice signal from the computer to an analog signal in the headset and reproduce the analog signal from right and left headphones (speakers) 26a and 26b.

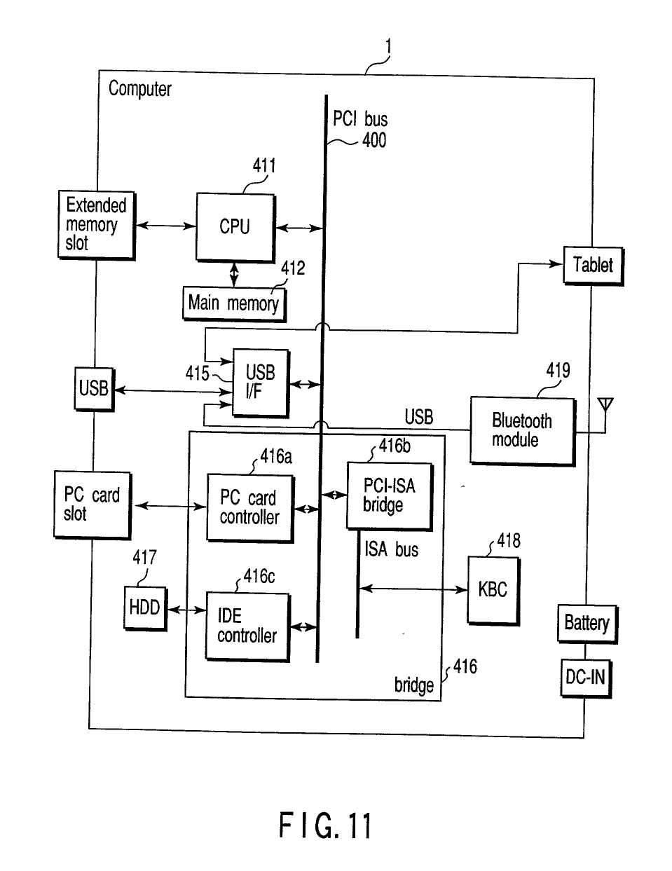

FIG. 11 provides a configuration example of the computer 1 with both the sound controller 413 and the sound CODEC 414 for implementing the sound function moved to the headset-mounted display device 2. The above-mentioned Bluetooth module 419 is used for an interface between the computer 1 and the headset-mounted display device 2.

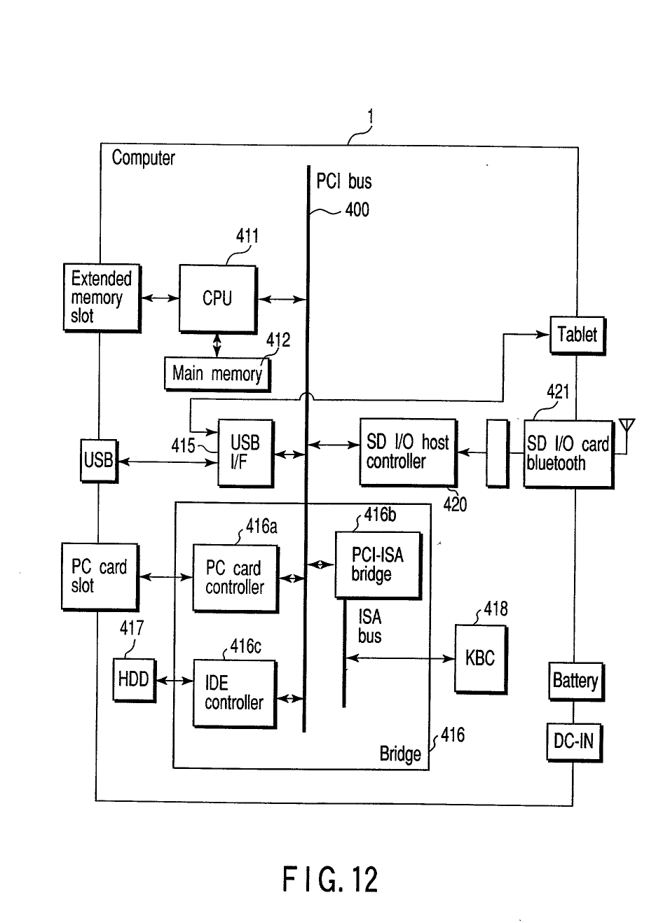

According to an example in FIG. 12, the computer 1 contains an SD (Secure Digital) I/O host controller 420 instead of the Bluetooth module 419. An I/O card 421 including the Bluetooth module is inserted into a card slot of the computer 1.

FIG. 13 shows a configuration example for the headset corresponding to FIG. 11 or 12. The headset is provided with the Bluetooth module 501, the microcontroller 502, and the sound CODEC 414. The microcontroller 502 can have various intelligent functions as needed in addition to the function of the sound controller 413.

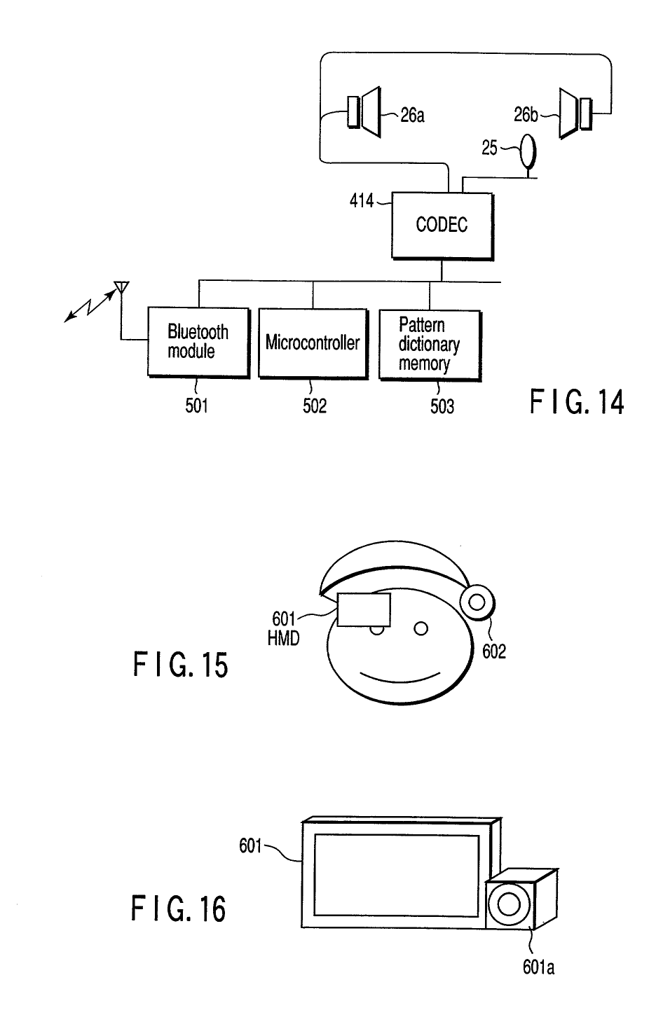

FIG. 14 is a further improvement of the configuration in FIG. 13 and is provided with a pattern dictionary memory 503 in addition to the Bluetooth module 501, the microcontroller 502, and the sound CODEC 414. The pattern dictionary memory 503 stores data for voice recognition and synthesis. The microcontroller 502 receives an input voice signal from the microphone 25 via the sound CODEC 414 and recognizes the voice signal based on the pattern dictionary memory 503. The microcontroller then transmits text for the dictation or a command to the computer 1 via the Bluetooth module 501. From the viewpoint of the computer 1, the headset functions as a keyboard or a mouse.

The microcontroller 502 converts the text or commands from the computer 1 to voice data (voice synthesis) based on the pattern dictionary memory 503 and outputs this voice data from the headphone via the sound CODEC 414.

The following describes another configuration of the headset-mounted display device 2 with reference to FIG. 15.

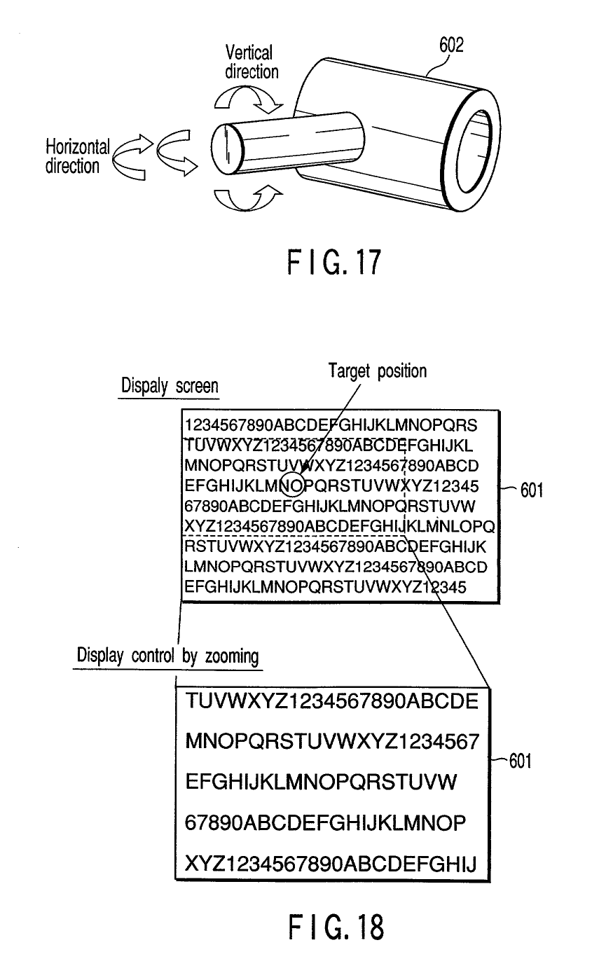

According to the configuration in FIG. 15, a video camera 602 is attached to the headset-mounted display device 2. An image acquired by the video camera 602 is transmitted to the computer 1, say, via a radio communication interface. This configuration uses a head-mounted display (HMD) 601 including a liquid crystal display instead of the above-mentioned display monitor 22. As shown in FIG. 16, the HMD 601 is provided with a video camera 601a for visual line recognition. The visual line recognition camera 601a acquires an image of the user's pupil. The microcontroller 502 analyzes this image to detect the user's visual line direction. According to a result of the detected visual line direction, the microcontroller 502 controls an image capturing direction of the video camera 602. As shown in FIG. 17, the video camera 602 is mounted rotatively in vertical and horizontal directions by means of a gear motor. Consequently, the image capturing direction can be easily varied only under control of the gear motor. This visual line detection control allows the video camera 602 to automatically capture an image corresponding to the user's visual line position and transmits this image to the computer 1.

Specifically, control is provided so that the HMD 601 simultaneously displays an image captured by the video camera 602. It is possible to apply the configuration that uses an image from the visual line recognition camera 601a for determining to which part of the display screen of the HMD 601 the visual line is directed. In this case, the image capturing direction is controlled only when the viewpoint is located on the display screen of the HMD 601. For example, when the user moves his or her visual line to the right end of the display screen of the HMD 601, the image capturing direction of the video camera 602 is controlled so that the video camera 602 displays a corresponding part of the image at the center of the screen. This enables a focused part of the image to be always centered on the display screen of the HMD 601. This means that it is possible to correctly transfer part of the image currently observed by the user to the computer 1. It is also possible to confirm the desired part of the image on the screen.

It is possible to further improve accuracy by applying the visual line detection and the voice recognition to the image capturing direction control of the video camera 602. For example, words such as “up”, “down”, “right”, and “left” are recognized, and the image capturing direction of the video camera 602 is adjusted according to a voice recognition result.

The configuration using a motor for controlling image capturing directions causes an increase in power consumption. For solving this, an image is taken by the video camera 602 at a wide angle beforehand. The focused part of the image is zoomed in by trimming, and then is transmitted to the computer or is displayed on the screen of the HMD 601 for confirmation. These operations can be also used for controlling image capturing directions as mentioned above. FIG. 18 shows how the display screen changes in this case. As shown in FIG. 18, focused part of the image is centered and enlarged on the screen. While looking at a workpiece with the naked eye, the user can confirm details by viewing the enlarged display image as needed.

As has been previously described, the system according to this embodiment can provide the computer 1 with small-sized, light-weight, and furthermore cableless features by efficiently distributing components to the computer 1 and the display device 2. This embodiment has explained the configuration which installs only the display controller 21 in the display device 2 and the configuration which installs the display controller 21 and the sound function in the display device 2. The embodiment can provide a sufficient effect when only the sound function is installed in the headset. Especially, working efficiency can be fully improved by combining intelligent functions such as the voice recognition, the voice synthesis, and the like.

It may be preferable to carry the computer 1, say, in a trouser pocket instead of attaching it to the user's waist.

As has been previously described in detail, the present invention can provide a computer system and a headset-mounted display device capable of being small-sized, light-weight and cableless, and allowing a user wearing the computer and the display device to work efficiently. Especially, it is possible to improve noise immunity by digitizing communication between the computer and the display device.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A computer system comprising:
a wearable computer; and
a wearable display device provided independently of said wearable computer, wherein said wearable display device includes:
a display monitor, and
a display controller which controls said display monitor and draws in a memory display data to be displayed on said display monitor based on drawing command information from said wearable computer.

2. The system according to claim 1, wherein said wearable display device has a headset-mounted casing wearable on a person's head.

3. The system according to claim 2, wherein:
said headset-mounted casing is provided with a speaker; and
said wearable display device further includes a sound circuit which generates a voice signal to be output from said speaker based on data from said wearable computer.

4. The system according to claim 3, wherein:
said wearable computer and said wearable display device each include a communication interface for radio communication with each other; and
said sound circuit generates said voice signal based on data transmitted from said wearable computer by radio.

5. The system according to claim 3, wherein said sound circuit includes:
a sound source which generates a digital voice signal based on data from said wearable computer; and
a converter which converts the digital voice signal obtained from said sound source to an analog voice signal.

6. The system according to claim 3, wherein:
said wearable computer is provided with a sound source; and
said sound circuit includes a converter which converts a digital voice signal from a sound source of said wearable computer to an analog voice signal.

7. The system according to claim 2, wherein:
said headset-mounted casing is provided with a microphone; and
said wearable display device further includes:
a voice recognition unit which recognizes a voice signal input from said microphone; and
a transmitting unit which transmits a command for controlling said wearable computer to said wearable computer based on a recognition result of said voice recognition unit.

8. The system according to claim 2, wherein:
said headset-mounted casing is provided with a microphone; and
said wearable display device further includes:
a converting unit which converts a voice signal input from said microphone to a digital signal; and
a transmitting unit which transmits the digital signal to said wearable computer.

9. The system according to claim 2, wherein:
said headset-mounted casing is provided with a camera; and
said wearable display device further includes:
a transmitting unit which transmits an image captured by said camera to said wearable computer;
a visual line detecting unit which detects a user's visual line position; and
a controlling unit which controls an image capturing direction of said camera based on a detection result of said visual line detecting unit so that said camera can capture an image corresponding to said user's visual line position.

10. The system according to claim 9, wherein:
said wearable display device further includes a unit for causing an image captured by said camera to be displayed on said display monitor via said display controller; and
said visual line detecting unit is configured to detect said user's visual line position with respect to a screen of said display monitor.

11. A computer system comprising:
a wearable computer; and
a wearable display device provided independently of said wearable computer and having a wearable headset-mounted casing, wherein
said wearable computer and said wearable display device each include a communication interface for radio communication with each other, and
said wearable display device includes:
a display monitor, and
a display controller which controls said display monitor and draws in a memory display data to be displayed on said display monitor based on drawing command information transmitted from said wearable computer by radio.

12. A headset-mounted display device constituting a computer system together with a computer, said headset-mounted display device comprising:
a display monitor; and
a display controller which controls said display monitor and draws in a memory display data to be displayed on said display monitor based on drawing command information transmitted from said computer by radio.

13. The device according to claim 12, further comprising:
a speaker; and
a sound circuit which generates a voice signal to be output from said speaker based on data from said computer.

14. The device according to claim 12, further comprising:
a microphone;
a voice recognition unit which recognizes a voice signal input from said microphone; and
a transmitting unit which transmits a command for controlling said computer to said computer based on a recognition result of said voice recognition unit.

15. The device according to claim 12, further comprising:
a microphone;
a converting unit which converts a voice signal input from said microphone to a digital signal; and
a transmitting unit which transmits the digital signal to said computer.

16. The device according to claim 12, further comprising:
a camera;
a transmitting unit which transmits an image captured by said camera to said computer;
a visual line detecting unit which detects a user's visual line position; and
a controlling unit which controls an image capturing direction of said camera based on a detection result of said visual line detecting unit so that said camera can capture an image corresponding to said user's visual line position.
